(19) United States
(12) Patent Application Publication
(10) Pub. No.: US 2026/0307241 A1
(43) Pub. Date: Oct. 8, 2026

(54) PRODUCTION PLANT AND METHOD FOR OPERATING A PRODUCTION PLANT HAVING A ROBOT AND A PROGRAMMABLE LOGIC CONTROLLER WITH RELATIVE ADDRESSING

(71) Applicants: thyssenkrupp Automotive Body Solutions GmbH, Heilbronn (DE); thyssenkrupp AG, Essen (DE)

(72) Inventors: Benjamin SEHR, Losheim am See (DE); Joerg EBERHARD, Worms (DE); Kevin NAUMANN, Namborn (DE)

(73) Assignees: thyssenkrupp Automotive Body Solutions GmbH, Heilbronn (DE); thyssenkrupp AG, Essen (DE)

(21) Appl. No.: 19/114,007

(22) PCT Filed: Sep. 18, 2023
(86) PCT No.: PCT/EP2023/075686

§ 371 Date: Mar. 21, 2025

(30) Foreign Application Priority Data
Sep. 22, 2022 (DE) 10 2022 209 987.7

(51) Int. Cl. B25J 9/16; G05B 19/05

(52) U.S. Cl. CPC B25J 9/161; G05B 19/05; G05B 2219/1134

(57) ABSTRACT

A method for operating a production plant having a robot and a programmable logic controller, wherein the robot is designed to apply multiple technologies and multiple functional units, wherein a communication between the robot, a functional unit assigned to the robot and the programmable logic controller takes place via a field bus, comprises, for initialization of the robot, allocating signal declarations for the technologies and signal declarations for the functional units a plurality of address ranges, comprising address fields, that can be accessed via the field bus, and allocating the signal declarations of each technology and the signal declarations of each functional unit a starting address, wherein the respective starting address is defined and called relative to a permanently defined reference address.

The invention relates to a method for operating a production plant having a robot and a programmable logic controller, wherein the robot is designed to apply multiple technologies and multiple functional units, in particular multiple tools and/or devices, wherein a communication between the robot, a functional unit allocated to the robot and the programmable logic controller takes place via a field bus, wherein for an initialization of the robot, signal declarations for the technologies and signal declarations for the functional units each being allocated a plurality of address ranges, comprising address fields, that can be accessed via the field bus, and wherein the signal declarations of each technology and the signal declarations of each functional unit are each allocated a start address. The signal declarations for the technologies and the signal declarations for the functional units define in particular how control is to take place for an operation and in particular how signals are sent and received via the field bus for this purpose.

Furthermore, the invention relates to a production plant having a robot which is designed to apply multiple technologies and multiple functional units, having a programmable logic controller, and having at least one functional unit which is allocated to the robot, wherein the robot, the functional unit allocated to the robot and the programmable logic controller are connected via a field bus for the transmission of signals.

Such production plants, which in particular comprise mechanical and electronic components, and methods for operating a production plant are known in the prior art. In particular, such highly automated production plants are used in the automotive industry for vehicle construction, especially in so-called body-in-white systems. For example, a robot of such a production plant can be designed for welding and clinching as possible technologies. A robot designed for welding includes a RSW gun (RSW: resistance spot welding) as a functional unit, for example. However, a robot can be designed to use multiple identical or different technologies and to use multiple identical or different tools and process devices as functional units. In abstract terms, a technology is, in particular, an encapsulated range of functions that can be instantiated as often as required and, in particular, extends the basic functions of the robot in order to perform special tasks within the production process, such as gripping a component or welding. Furthermore, a technology can in particular include functions to make an associated functional unit or associated functional units usable with the robot controller. In addition, the technology can in particular include functions for exchanging signals with the higher-level programmable logic controller (PLC for short).

The electronic components of the production plant, also known as field devices, are connected to each other via a field bus and communicate via this bus. Components of the production plant or field devices are in particular PLCs, robots, welding controllers, tool changers, grippers, stations, conveyor technology etc., wherein functional units are in particular subordinate field devices of the robot controller. The field bus connects the field devices with an automation device in a known manner and is used for the digital, bidirectional exchange of data, in particular signals and/or other information. For communication between the field devices, in particular between a robot and a functional unit, a previously defined and limited address range is available in the current state of the art in such a production plant, in which it is specified how the field devices send and receive data via the field bus. Each field device is allocated its own address range on the field bus. The robot is initialized by virtue of signals being allocated to the address ranges of the field devices on the field bus. This allocation is usually defined and prescribed by the OEM (Original Equipment Manufacturer). Different technologies occupy different address ranges. As there are significantly more technologies than address ranges, the address ranges must be allocated multiple times, which is illustrated by the following table, wherein “I/O” stands for “input/output”, and therefore a data exchange, and “PLC” for “programmable logic controller”.

This means that the constant start address of the base interface is located at a start address A, for example at bit “0”, for all three robot variants. The start address is the first address of a respective field device. The constant end address of the base interface for the three robot variants is located at the end address B, for example at bit “127”. The constant start address of technology interface 1 for robot “variant 1” is located at the start address C, for example at bit “128”. The constant start address of technology interface 2 for robots “variant 1” and “variant 2” or the constant start address of technology interface 5 for robot “variant 3” is located at the start address D, for example at bit “180”. The constant start address of technology interface 3 for the robots “variant 1” and “variant 3” is located at the start address E, for example at bit “253”. The constant start address of technology interface 4 for the robots “variant 1” and “variant 2” or the constant start address of technology interface 7 for the robot “variant 3” is located at the start address F, for example at bit “386”. The end address G, for example at bit “4096”, is the constant end address of the technology interfaces for all three robots.

However, such a static specification of the technologies means that the technologies cannot be combined with each other as desired. Only certain technology combinations are available. For example, technology 2 cannot be provided in addition to technology 5 for robot “variant 3”, as the corresponding address range has already been allocated. This reduces the flexibility in the use of the robots of the production plants and, in the worst case, leads to an increase in the number of robots so that the required technologies can be used. In addition to the lack of flexibility, a previous OEM standard is also tied to the fact that different producers of a functional unit implement an identical and/or a predefined I/O interface. In addition, these functional units from different producers must behave almost identically so that the production plant can be operated as intended.

Against this background, it is an object of the present invention to improve a method for operating a production plant having a robot and a programmable logic controller as well as a production plant having a robot and a programmable logic controller, in particular in such a way that the robots can be used more flexibly for predeterminable technologies and functional units, such as tools and other process devices, in extensive combination.

To solve this problem, a method for operating a production plant according to claim 1 and a production plant according to the coordinated claim are proposed. Further advantageous embodiments of the invention are described in the dependent claims and the description and are shown in the figures.

The proposed solution provides a method for operating a production plant having a robot and a programmable logic controller, wherein the robot is designed to apply multiple technologies and multiple functional units. Communication between the robot, a functional unit allocated to the robot, in particular a tool or another type of field device, and the programmable logic controller (PLC) takes place via a field bus, wherein for initialization of the robot, signal declarations for the technologies and signal declarations for the functional units each being allocated to a plurality of address ranges, comprising address fields, that can be accessed via the field bus.

The signal declarations of each technology and the signal declarations of each functional unit are each allocated a start address, wherein the respective start address is defined relative to a permanently defined reference address. In particular, dynamically calculated signal addresses are used for the configuration of a necessary signal exchange between the individual functional units. Advantageously, the signal ranges for the technology-related signal exchange with the PLC and for the signal exchange with the process-relevant technology devices are each allocated a start address, wherein the respective start address is advantageously defined relative to a permanently defined reference address. The respective start address is in particular the first address of a respective field device. In particular, it is provided that the signal declarations of each technology are each allocated a start address relative to a first permanently defined reference address and the signal declarations of each functional unit are each allocated a start address relative to a fixed second reference address. This advantageously enables a flexible and technology-independent serialization of technology and/or device address ranges, which in turn advantageously enables diverse combinations of technologies and functional units that a robot can use.

The relative indices of the signal declarations to the PLC and the associated functional units advantageously define the respective technology. During initialization, each field device advantageously receives its own signal range in the robot controller, which is advantageously allocated to the corresponding address range on the field bus. This address range is used in particular for signal exchange, in particular for signal exchange with the higher-level controller, in particular with the PLC and/or the robot, and also in particular for processing inputs and/or providing outputs. If a technology contains multiple functional units, it is advantageously provided that the signal ranges are connected to each other and form a higher-level signal range of the technology instance. A signal range comprises in particular multiple signal declarations, and each technology comprises in particular multiple signal declarations.

Furthermore, it is particularly envisaged that the production plant is a highly automated production plant, in particular a highly automated motor vehicle production plant. In particular, the production plant may comprise multiple robots. In particular, each robot of the production plant can be designed to use multiple identical technologies, for example to perform multiple welding processes, to use identical and different technologies, for example to perform multiple welding processes and clinching, or to use only different technologies, for example for self-pierce riveting, gluing and riveting. In addition, a robot can be designed to use one or more functional units, in particular one or more tools and/or other process devices. Multiple identical functional units, identical and different functional units or only different functional units can be allocated to a robot. However, the start addresses for the different technologies and the start addresses for the different functional units are advantageously no longer allocated exclusively to fixed address ranges that start at fixed bit positions. Instead, as already explained, the start addresses are advantageously defined relative to a permanently defined reference address, wherein the reference address can be different in particular for the technologies and the functional units.

According to an advantageous embodiment, it is provided that the reference address is equal to the first start address of signal declarations of a first technology, i.e., the reference address corresponds to the first start address of signal declarations of a first technology. This start address is advantageously connected to the end address of a base interface in which base inputs and outputs are defined. Advantageously, this first start address of the first technology is used for the relative definition of the start addresses for all further technologies. There is therefore advantageously only one permanently defined reference address for the technologies.

In particular, it may also be provided that the start addresses for the functional units are also defined in relation to this first start address of the first technology. However, it is preferred that a first start address of signal declarations of a first functional unit is allocated to a further permanently defined reference address, which is independent of the first start address of signal declarations of the first technology. Advantageously, this means that the allocation of signal declarations of the technologies and the allocation of signal declarations of the functional units are clearly separated. This can also simplify implementation. This can also simplify daily use.

Advantageously, for initialization on the robot side, the signal declarations of a respective technology are allocated to the address range serially starting at the reference address. It is also advantageous for the robot-side initialization to allocate the signal declarations of a respective functional unit to the address range serially, starting at the reference address. Serialization is advantageously based on the fact that flexible start addresses are defined and the technologies or functional units are then arranged serially. The available address ranges can thus be better utilized.

According to a further advantageous embodiment, the signal declarations for the technologies are allocated to directly successive address ranges, wherein the start address of signal declarations of a subsequent technology is allocated to an address field that follows a last address field occupied by signal declarations of a preceding technology. The address ranges are thus advantageously strung together additively, wherein for each technology advantageously only exactly the required number of address fields or bits is allocated. This number of address fields or bits for a particular technology is also referred to below as the technology width. The address ranges thus result in particular in addition to “first start address of the first technology”+“technology width 1”+“technology width 2”+ . . . + “technology width n”. Advantageously, any combination of technologies can thus be flexibly enabled and new technologies can be integrated in a simplified manner if required.

A further advantageous embodiment is that the signal declarations for the functional units are allocated to directly successive address ranges, wherein the start address of signal declarations of a subsequent functional unit is allocated to an address field that follows a last address field occupied by signal declarations of a preceding functional unit. The address ranges are thus advantageously strung together, wherein for each functional unit advantageously only exactly the required number of address fields or bits is allocated. This number of address fields or bits for a respective functional unit is also referred to below as the functional unit width. The address ranges thus result in particular in addition to “first start address of the first functional unit”+“functional unit width 1”+“functional unit width 2”+ . . . + “functional unit width n” or alternatively to “first start address of the first technology”+“technology width 1”+“technology width 2”+ . . . +“technology width n”+“functional unit width 1”+“functional unit width 2”+ . . . + “functional unit width n”. Advantageously, any combination of functional units can thus be flexibly enabled and new functional units can be easily integrated if required.

The fact that the signal declarations are advantageously allocated to directly consecutive address ranges means that the limited resource “address range” is advantageously utilized very well. In addition, multiple technologies and/or functional units can advantageously be allocated to one robot, especially for longer cycle times.

A further embodiment provides for the start address of signal declarations for a first functional unit to be allocated to an address field that follows an address range that adjoins a last address field occupied by signal declarations of a last technology. This further increases flexibility. According to an advantageous design variant, however, the start address of signal declarations for a first functional unit is allocated to an address field with a further permanently defined reference address. Advantageously, this separation of technologies and functional units results in various simplifications in practice, particularly with regard to current production plants. In particular, there can be multiple unallocated address fields between the address field of a last signal declaration of a last technology and the permanently defined reference address.

By allocating signal declarations for a respective technology to an address range, inputs and outputs for the respective technology are advantageously configured in each case for a device field bus interface of the production plant. Further advantageously, by allocating signal declarations for a respective technology to an address range, inputs and outputs for the respective technology are configured in each case for a PLC field bus interface of the programmable logic controller. Advantageously, the respective technology can then be used directly.

In particular, by allocating signal declarations for a respective technology to an address range, technology information for the respective technology is stored in a memory unit of the robot. This technology information relates in particular to the start addresses for the signal exchange with the PLC and the functional units. In addition, the distinction between similar technologies that differ in terms of the functional units can be stored. In particular, a distinction can be made between the different implementations of a specific technology in terms of signal configuration and sequence between producer A and producer B. Advantageously, the number of functional units can also be configured. It is possible to use different producers in one technology.

It is also advantageous to store a number of address fields that are occupied for a particular technology in an address range. Advantageously, this results in the technology width or functional unit width. The stored information is then advantageously used, for example, when a technology is called up in order to determine the start address of the called-up technology based on the reference address and the respective number of address fields.

According to a further advantageous embodiment of the method, it is provided that the programmable logic controller is initialized in addition to the initialization of the robot, wherein the initialization of the programmable logic controller takes place in particular in parallel with the initialization of the robot. Advantageously, the respective technologies and/or functional units are thus successively fully designed for an application.

Furthermore, the data representing the different technologies are advantageously instantiated and parameterized during the initialization of the programmable logic controller. Advantageously, the technologies are thus adapted for the specific application.

A further advantageous embodiment of the method provides that in order to execute one of the technologies using the robot, the respective start address is called up relative to the permanently defined reference address. In particular, to execute one of the technologies using the robot, the respective start address is called up relative to the first start address of the first technology, wherein the respective start address of a technology “n” is called up in particular as the sum “first start address of the first technology”+“technology width 1”+“technology width 2”+ . . . + “technology width n−1”.

Further advantageously, the respective start address is called up relative to the permanently defined reference address, in particular relative to the permanently defined further reference address, in order to use one of the functional units when using the robot. In particular, to execute one of the functional units in connection with the use of the robot, the respective start address is called up relative to the first start address of the first functional unit, wherein the respective start address of a functional unit “m” is called up in particular as the sum “first start address of the first functional unit”+“functional unit width 1”+“functional unit width 2”+ . . . + “functional unit width m−1”.

In particular, it is intended that when a technology command relating to one of the technologies is called up, a query is made regarding the start address of the corresponding technology. In particular, the distance, i.e., the number of address fields, between the start address of the corresponding technology and the first start address of the first technology is determined. This distance is also referred to below as the “I/O offset” (I/O: input/output).

Advantageously, a start address of signal declarations to be called up is called up starting from the reference address as the sum of the number of address fields of subsequent signal declarations for the technologies and/or for the functional units up to a last address field of signal declarations immediately preceding the target data. The signal declarations to be called up are the signal declarations stored in the address range for the selected technology or the selected functional unit. To call up the start address of signal declarations of a technology to be called up, the reference address is in particular the same as the first start address of the first technology. To call up the start address of signal declarations of a functional unit to be called up, the reference address is in particular equal to the first start address of the first functional unit.

For communication between the robot and the programmable logic controller, an address field distance between the reference address and a respective start address is advantageously used in each case when executing a technology command. Further advantageously, an address field distance between the further reference address and a respective start address of a functional unit is used in each case for communication between the robot and a respective functional unit. Advantageously, therefore, no fixed addresses need to be defined for each technology and each functional unit in order to be able to execute a technology command. Since the address field spacing can change when the technology combinations change or when the combinations of the functional units change, a respective technology can advantageously still be called up via the changed address field spacing, advantageously without having to make any further adjustments.

The following table illustrates an advantageous allocation of the address ranges as explained above. Here, “I/O” stands for “input/output”, “PLC” for “programmable logic controller”, TW for technology width and FW for functional unit width.

In this configuration, the start address of the base interface is located at a start address A, but this could also in principle be flexibly defined as a permanently defined reference address. The end address of the base interface is located at the end address B, but this also does not have to be fixed. The first start address C of technology 1 is fixed as the first reference address for the technologies that can be used by the robot. TW1 is the flexible width of the technology interface for technology 1 and is a specific number of address fields. TW2 is the flexible width of the technology interface for technology 2 and is also a specific number of address fields. The end address D is the flexible end address that results for the technology interfaces. The first start address E of the functional unit 1 is fixed as the second permanently defined reference address for the functional units that can be used by the robot. FW1 is the flexible width of the functional unit interface for functional unit 1 and is a specific number of address fields. FW2 is the flexible width of the functional unit interface for functional unit 2 and is a specific number of address fields. The end address F is the flexible end address that results for the functional unit interfaces.

The production plant furthermore proposed for achieving the object mentioned at the outset, having a robot which is designed for the application of a plurality of technologies and a plurality of functional units, a programmable logic controller, and at least one functional unit which is allocated to the robot, wherein the robot, the functional unit allocated to the robot and the programmable logic controller are connected for the transmission of data via a field bus, is designed for operation in accordance with a method designed according to the invention. In particular, the production plant is thus designed so that a respective start address of a technology or a functional unit is defined relative to a permanently defined reference address and the respective start address of a technology or a functional unit is called up relative to the permanently defined reference address. In particular, the production plant is a highly automated production plant, especially a motor vehicle production plant.

Further advantageous details, features and embodiment details of the invention are explained in greater detail in conjunction with the exemplary embodiments shown in the figures, in which:

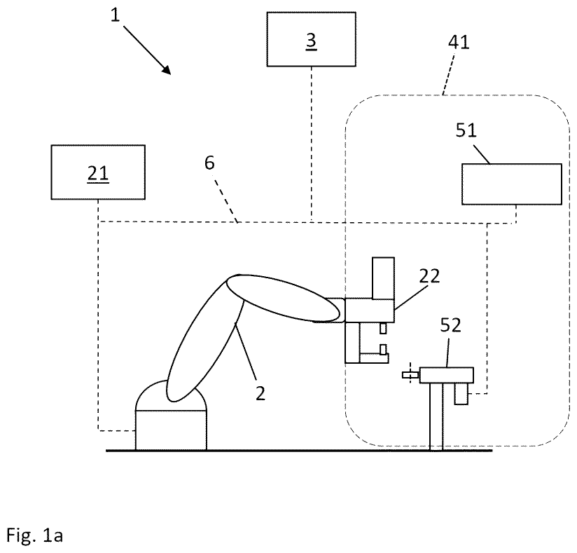

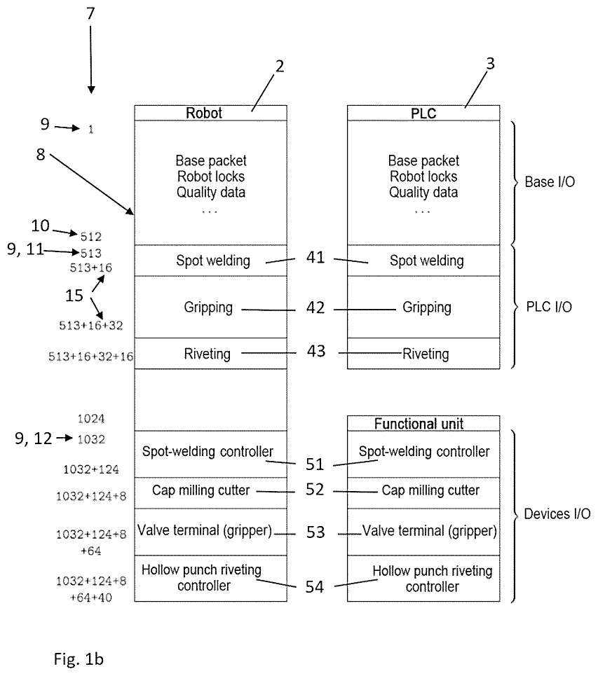

FIG. 1a shows, in a highly simplified schematic representation, an exemplary embodiment of a production plant designed according to the invention;

FIG. 1b shows, in a schematic representation, an exemplary embodiment for addressing technologies and functions according to a method according to the invention; and

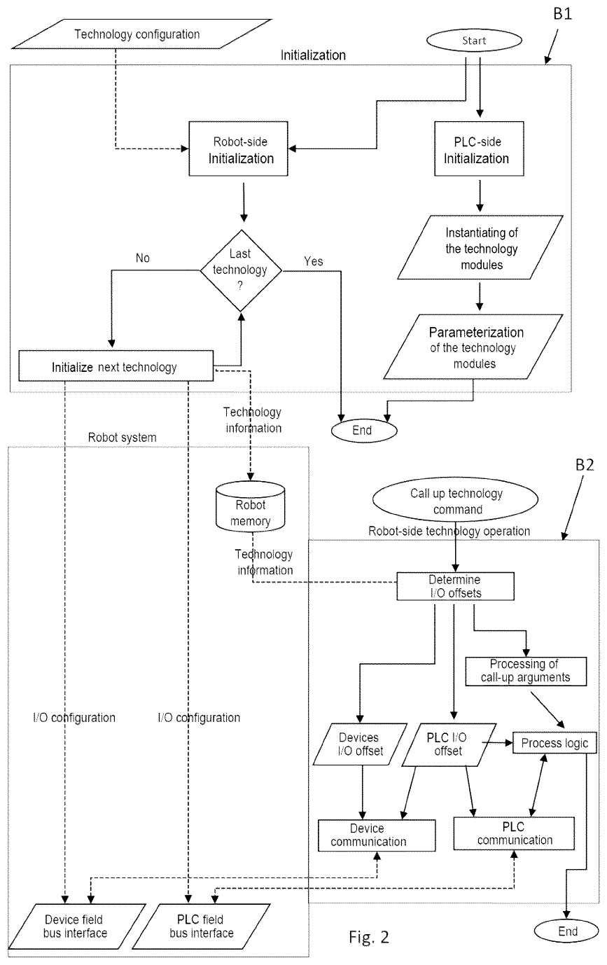

FIG. 2 shows, in a flow chart, an exemplary embodiment of a method according to the invention.

With reference to FIG. 1a and FIG. 1b, an exemplary embodiment of a production plant 1 designed according to the invention having a robot 2, a programmable logic controller 3 and two functional units 51, 52 allocated to the robot 2 is explained. The robot 2 is designed to apply multiple technologies 41, 42, 43 and multiple functional units 51, 52, 53, 54. Thus, in this exemplary embodiment, it is provided that the robot 2 is designed to use the technologies of spot welding 41, gripping 42 and riveting 43. This means that the robot 2 is designed to carry out these technologies 41, 42, 43 when appropriately controlled. In this exemplary embodiment, the robot 2 is also designed to use the functional units of spot-welding controller 51, cap milling cutter 52, valve terminal 53 and hollow punch riveting controller 54. These functional units 51, 52, 53, 54 are associated with the technologies 41, 42, 43, which the robot 2 is designed to use. In this exemplary embodiment, however, only a cap milling cutter 52 and a spot-welding controller 51 are allocated to the robot 2 as functional units. In this exemplary embodiment, the robot 2 also comprises a RSW gun 22 (RSW: resistance spot welding), which is not defined as a further functional unit but is allocated directly to the robot 2 and which, like the entire robot 2, is controlled via the robot controller 21. The robot 2, the robot controller 21, the programmable logic controller 3, the cap milling cutter 52 allocated to the robot 2 and the spot-welding controller 51 allocated to the robot 2 are connected to each other via a field bus 6, wherein data required for operating the production plant is transmitted via this field bus 6. In particular, a data packet comprises at least one address and the binary information. In particular, the binary information describes signals that can represent the measurement data of a sensor or the switching state of an actuator.

The robot controller 21 itself is a field device that is connected both to the higher-level programmable logic controller and to lower-level field devices, such as the spot-welding controller 51 in this example. In this exemplary embodiment, the robot controller 21 uses signal declarations that can be formed both internally from variables of the robot controller 21 itself and on address ranges of the field bus 6. These signal declarations can be used numerically during the control sequence, in particular via an index, or symbolically, in particular via a name. The arrangement of these signal declarations is in particular independent of the respective address ranges of the field bus 6. The allocation of address to signal declaration for the robot controller is defined during commissioning during initialization.

In order to be able to operate the production plant 1, signal declarations for the various technologies 41, 42, 43 and signal declarations for the various functional units 51, 52, 53, 54 are each allocated to address ranges 8, as shown in FIG. 1b, which can be accessed via the field bus 6, for initialization of the robot 2. The address ranges 8 have a number of address fields 7, each of which can be addressed via an address. The signal declarations of each technology 41, 42, 43 are each allocated a start address 9, which is defined and called up relative to a fixed first reference address 11, and the signal declarations of each functional unit 51, 52, 53, 54 are each allocated a start address 9, which is defined and called up relative to a fixed second reference address 12. The signal declarations for the technologies 41, 42, 43 are allocated serially to the address range 8 starting at the first reference address 11 and the signal declarations for the functional units 51, 52, 53, 54 are allocated serially to the address range 8 starting at the second reference address 12.

In a first address range 8, which in this exemplary embodiment, as shown in FIG. 1b, is defined from a bit “1” as the start address 9 to a bit “512” as the end address 10, a base packet of signal declarations is initially stored, which relate in particular to robot locks, quality data, etc. The signal declarations of the first technology spot welding 41 are allocated to the directly adjacent address range 8 with bit “513” as start address 9. The signal declarations of the first technology spot welding 41 occupy sixteen address fields 7, so that the technology width is 16 bits. For the first technology 41 and the other technologies 42, 43, the start address 9 for spot welding 41 is defined at bit “513” as a permanently defined reference address. The signal declarations of the other technologies 42, 43 are then allocated to immediately successive address ranges 8, wherein the start address 9 of signal declarations of a subsequent technology is allocated to an address field 7 that follows a last address field 7 occupied by signal declarations of a preceding technology. This means that the start address 9 for the second gripping technology 42 results from the reference address “513” and the address field spacing 15 resulting from the technology width, which in this case is 16 bits, as the sum of 513 and 16 to 529. Since the second technology, gripping 42, has a technology width of 32 bits in this example, the address field distance to the reference address 513 bits is therefore 16+32 and the start address for the third technology, riveting 43, is the sum of 513+16+32. There are no unused address fields 7 between the technologies spot welding 41 and gripping 42 and between the technologies gripping 42 and riveting 43. The address ranges 8 are thus optimally utilized. However, a number of unused address fields 7, i.e., address fields 7 to which no signal declarations are allocated, are provided between the end address of the last technology 43 and the start address 9 of the first functional unit spot-welding controller 51. The start address 9 of the first functional unit spot-welding controller 51 is at bit “1032” and is the reference address 12 for this functional unit 51 and the other functional units 52, 53, 54 for allocating and calling up the respective start address 9 of a respective functional unit. Here too, the address ranges 8 are written directly one after the other starting from the reference address 12 with the signal declarations for the functional units 51, 52, 53, 54 and the functional unit width, i.e., the address spacing starting from the start address to the end address of the signal declarations for a respective functional unit, is stored in order to be able to call up the start addresses for use. In this example, the functional unit spot-welding controller 51 has an address field distance of 124 bits, the functional unit cap milling cutter 52 has an address field distance of 124+8 bits, the functional unit valve terminal 53 has an address field distance of 124+8+64 bits and the functional unit hollow punch riveting controller 54 has an address field distance of 124+8+64+40 to the reference address 12 at bit “1032”. This type of relative definition of the start addresses means that further technologies and further functional units can be easily added or exchanged for existing ones in order to be able to convert the robot 2 accordingly. The combinability of technologies and the combinability of functional units is thus only subject to the restriction of the overall limited address field range 8, but not to any limitation by fixed start addresses for technologies and functional units that are firmly allocated and anchored in standards, as illustrated by the table below.

Combinability according to the prior art:

Combinability according to the invention:

For example, technology 1 can mean riveting, instance 1 can mean first rivet controller and instance 2 can mean second rivet controller.

In FIG. 2, an initialization B1 and an execution of technology commands B2 in connection with the execution of a method according to the invention are shown as an example in a flow chart. In particular, the production plant can be a production plant as explained with reference to FIG. 1a and FIG. 1b. The term I/O offset corresponds to the term address field distance.

Block B1 shows the initialization on the robot side and the PLC side as part of a technology configuration. The technologies that are to be configured are initialized successively. During the initialization of the programmable logic controller, the data representing the different technologies is successively instantiated and parameterized. In addition, by allocating data for a respective technology to an address range (field: “initialize next technology”), inputs and outputs for the respective technology are configured in each case for a device field bus interface as a functional unit field bus interface and inputs and outputs for the respective technology are configured in each case for a PLC field bus interface of the programmable logic controller, which is designated by “I/O configuration” in FIG. 2.

In addition, with the allocation of signal declarations for a respective technology to an address range, technology information for the respective technology is stored in a memory unit of the robot, referred to as “robot memory” in FIG. 2, and a number of address fields occupied for a respective technology in an address range are stored. Since the signal declarations for the technology are written serially one after the other, the information regarding the number of occupied address fields for a respective technology is used for addressing the respective technology relative to a reference address, as already explained above with reference to FIG. 1b, when a technology command (block B2) is called up. To execute an initialized technology using the robot, the respective start address of the selected technology is therefore called up relative to the permanently defined reference address. For this purpose, when a technology command relating to one of the technologies is called up, a query is made regarding the start address of the corresponding technology, which is shown in the “determine I/O offsets” field in FIG. 2. There are therefore no fixed start addresses stored for the technologies; the respective start address must first be determined. The same applies to the functional units.

The embodiments shown in the figures and explained in conjunction therewith serve to illustrate the invention and are not limiting with respect thereto.

### LIST OF REFERENCE SIGNS

1 production plant
2 robot
21 robot controller
22 RSW gun
3 programmable logic controller
41 first technology
42 second technology
43 third technology
51 first functional unit
52 second functional unit
53 third functional unit
54 fourth functional unit
6 field bus
7 address field
8 address range
9 start address
10 end address
11 first reference address
12 second reference address
15 address field spacing
B1 “initialization” block
B2 “execution of technology commands” block

1-19. (canceled)

20. A method for operating a production plant having a robot and a programmable logic controller, wherein the robot is designed to apply multiple technologies and multiple functional units, and wherein a communication between the robot, a functional unit assigned to the robot and the programmable logic controller takes place via a field bus, the method comprising:
for initialization of the robot, allocating signal declarations for the technologies and signal declarations for the functional units a plurality of address ranges, comprising address fields, that can be accessed via the field bus; and
allocating the signal declarations of each technology and the signal declarations of each functional unit a starting address;
wherein the respective starting address is defined relative to a permanently defined reference address.

21. The method as claimed in claim 20, wherein the reference address corresponds to the first start address of signal declarations of a first technology.

22. The method as claimed in claim 20, wherein for initialization on the robot side, the signal declarations of a respective technology and the signal declarations of a respective functional unit are allocated to the address range serially starting at the reference address.

23. The method as claimed in claim 20, wherein the signal declarations for the technologies are allocated to directly successive address ranges, wherein the start address of signal declarations of a subsequent technology is allocated to an address field that follows a last address field occupied by signal declarations of a preceding technology.

24. The method as claimed in claim 20, wherein the signal declarations for the functional units are allocated to directly successive address ranges, wherein the start address of signal declarations of a subsequent functional unit is allocated to an address field that follows a last address field occupied by signal declarations of a preceding functional unit.

25. The method as claimed in claim 20, wherein the start address of signal declarations for a first functional unit is allocated to an address field that follows an address range that adjoins a last address field occupied by signal declarations of a last technology.

26. The method as claimed in claim 20, wherein the start address of signal declarations for a first functional unit is allocated to an address field with a further permanently defined reference address.

27. The method as claimed in claim 20, wherein, by allocating signal declarations for a respective technology to an address range, inputs and outputs for the respective technology are configured in each case for a functional unit field bus interface.

28. The method as claimed in claim 20, wherein, by allocating signal declarations for a respective technology to an address range, inputs and outputs for the respective technology are configured in each case for a PLC field bus interface of the programmable logic controller.

29. The method as claimed in claim 20, wherein, by allocating signal declarations for a respective technology to an address range, technology information for the respective technology is stored in a memory unit of the robot.

30. The method as claimed in claim 20, wherein a number of address fields that are occupied for a particular technology in an address range are stored.

31. The method as claimed in claim 20, wherein the programmable logic controller is initialized in addition to the initialization of the robot.

32. The method as claimed in claim 31, wherein the data representing the different technologies are instantiated and parameterized during the initialization of the programmable logic controller.

33. The method as claimed in claim 20, wherein, in order to execute one of the technologies using the robot, the respective start address is called up relative to the permanently defined reference address.

34. The method as claimed in claim 20, wherein the respective start address is called up relative to the permanently defined reference address or relative to the permanently defined further reference address, in order to use one of the functional units when using the robot.

35. The method as claimed in claim 20, wherein, when a technology command relating to one of the technologies is called up, a query is made regarding the start address of the corresponding technology.

36. The method as claimed in claim 20, wherein a start address of signal declarations to be called up is called up starting from the reference address as the sum of the number of address fields of subsequent signal declarations for the technologies and/or for the functional units up to a last address field of signal declarations immediately preceding the signal declarations to be called up.

37. The method as claimed in claim 20, wherein an address field distance between the reference address and a respective start address is used in each case for communication between the robot and the programmable logic controller when executing a technology command, and/or in that an address field distance between the further reference address and a respective start address is used in each case for communication between the robot and a respective functional unit.

38. A production plant having a robot which is designed to apply multiple technologies and multiple functional units, having a programmable logic controller, and having at least one functional unit which is allocated to the robot, wherein the robot, the at least one functional unit allocated to the robot and the programmable logic controller are connected via a field bus for the transmission of data, wherein the production plant is configured for operation as claimed in claim 20.
